(19) United States
(12) Patent Application Publication
(10) Pub. No.: US 2006/0092111 A1
(43) Pub. Date: May 4, 2006

(54) Liquid crystal display device

(76) Inventors: Kenji Nakao, Kanazawa-shi (JP); Seiji Kawaguchi, Hirakata-shi (JP); Yukio Tanaka, Kanazawa-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/254,683

(22) Filed: Oct. 21, 2005

(30) Foreign Application Priority Data
Oct. 22, 2004 (JP) 2004-308303

(51) Int. Cl. G09G 3/36

(52) U.S. Cl. 345/87

(57) ABSTRACT

A liquid crystal display device comprises a display panel including a pair of electrode substrates and a liquid crystal layer that is held between the electrode substrates and contains a liquid crystal material whose molecules are transferred in advance from a splay alignment to a bend alignment, and a display panel control circuit that controls transmittance of the display panel by a liquid crystal driving voltage. In particular, the display panel has a voltage-transmittance characteristic that a minimum value and maximum value of the transmittance are obtained in a state where the liquid crystal driving voltage exceeds a transfer threshold level at which an energy of the splay alignment is balanced with an energy of the bend alignment, and the display panel control circuit is configured to vary the liquid crystal driving voltage in a range corresponding to the minimum and maximum values of transmittance.

### CROSS-REFERENCE TO RELATED APPLICATIONS

This application is based upon and claims the benefit of priority from prior Japanese Patent Application No. 2004-308303, filed Oct. 22, 2004, the entire contents of which are incorporated herein by reference.

### BACKGROUND OF THE INVENTION

1. Field of the Invention

The present invention relates to a liquid crystal display device including a liquid crystal display panel of an OCB (Optically Compensated Birefringence) mode.

2. Description of the Related Art

Flat-panel display devices, which are typified by liquid crystal display devices, have widely been used as display devices for computers, car navigation systems, TV receivers, etc.

The liquid crystal display device generally includes a liquid crystal display panel including a matrix array of liquid crystal pixels, and a display panel control circuit that controls the display panel. The liquid crystal display panel is configured such that a liquid crystal layer is held between an array substrate and a counter substrate. The array substrate includes a plurality of pixel electrodes that are arrayed substantially in a matrix, a plurality of gate lines that are arranged along the rows of pixel electrodes, a plurality of source lines that are arranged along the columns of pixel electrodes, and a plurality of switching elements that are arranged near intersections between the gate lines and the source lines. Each of the switching elements is formed of, e.g. a thin-film transistor. When one associated gate line is driven, the thin-film transistor is turned on to apply a potential of one associated source line to one associated pixel electrode. The counter substrate is provided with a common electrode that is opposed to the pixel electrodes arrayed on the array substrate. Each pair of pixel electrode and common electrode is associated with a pixel area of the liquid crystal layer to constitute a pixel. In the pixel area, the alignment of liquid crystal molecules is controlled by an electric field between the pixel electrode and the common electrode. The display panel control circuit includes a gate driver that is connected to the gate lines, a source driver that is connected to the source lines, and a controller that controls the operation timings of the gate driver and the source driver.

The gate driver sequentially drives the gate lines in one frame period (vertical scan period) that is an updating period of image data that comprises pixel data for the pixels. The source driver converts pixel data for the pixels of one row, to pixel voltages while each gate line is driven by the gate driver, and outputs the pixel voltages to the source lines in parallel. The pixel voltages are supplied to the associated pixel electrodes via the switching elements of one row, which are assigned to the driven gate line. As a result, a potential difference between the pixel electrode and the common electrode set at, e.g. 0V, is applied as a D liquid crystal driving voltage to the pixel area of the liquid crystal layer, which is held between the pixel electrode and the common electrode. The pixel electrode and common electrode are insulated from each other by the liquid crystal layer and serve as a liquid crystal capacitance. The liquid crystal capacitance is charged to a pixel voltage in a period the switching element is maintained conductive. Even after the switching element is rendered non-conductive, the liquid crystal capacitance retains the charge until the switching element is rendered conductive once again after one frame period. In short, the liquid crystal display panel is a hold-type display panel that holds the display state until the image data is updated.

If the direction of an electric field between the pixel electrode and the common electrode is unchanged, non-uniform distribution of liquid crystal molecules progresses, finally leading to a state where the alignment of liquid crystal molecules is uncontrollable. In order to prevent this problem, the polarity of the pixel voltage is reversed, relative to the potential of the common electrode, for example, in every 1-frame period. In addition, flicker of a display image is prevented by line-reversal driving in which the polarity of the pixel voltage is reversed on a row-by-row basis, or dot-reversal driving in which the polarity of the pixel voltage is reversed on a pixel-by-pixel basis in each row and each column.

In the case where the liquid crystal display device is used for a TV receiver that principally displays a moving image, a liquid crystal display panel of an OCB mode, in which liquid crystal molecules exhibit good responsivity, is generally used (see Jpn. Pat. Appln. KOKAI Publication No. 2002-202491). In the liquid crystal display panel, the liquid crystal molecules for the OCB mode are aligned in a splay alignment, as shown in part (a) of FIG. 7, before supply of power. This splay alignment is a state where the liquid crystal molecules are laid down, and obtained by alignment films which are disposed on the pixel electrode and the counter electrode and rubbed in parallel with each other. The liquid crystal display panel performs an initializing process upon supply of power. In this process, a relatively strong electric field is applied to the liquid crystal molecules to transfer the splay alignment to a bend alignment, as shown in parts (b) and (c) of FIG. 7. A display operation is performed after the initializing process.

FIG. 8 shows energies of the splay alignment and bend alignment, relative to the liquid crystal driving voltage. The reason why the liquid crystal molecules are aligned in the splay alignment before supply of power is that the splay alignment is more stable than the bend alignment in terms of energy in a state where the liquid crystal driving voltage is not applied. In FIG. 8, Vc indicates a transfer threshold level of the liquid crystal driving voltage, at which the energy of splay alignment is balanced with the energy of bend alignment, and Vc =about 1.6V. As a characteristic of the liquid crystal molecules for the OCB mode, the bend alignment tends to be inverse-transferred to the splay alignment if a state where no voltage is applied or a state where a voltage lower than the level Vc is applied, continues for a long time. The viewing angle characteristic of the splay alignment significantly differs from that of the bend alignment. Thus, a normal display is not attained in this splay alignment.

In a conventional driving method that prevents the inverse-transfer from the bend alignment to the splay alignment, a high voltage is applied to the liquid crystal molecules in a part of a frame period for a display of a 1-frame image, for example. This high voltage corresponds to a pixel voltage for a black display in an OCB-mode liquid crystal display panel, which is a normally-white type, so this driving method is called “black insertion driving.” However, in the black insertion driving, since each pixel performs black display at a predetermined ratio in one frame period, such a problem arises that the luminance of the display panel, as a whole, decreases. Besides, in order to perform black display at proper timing, a complicated circuit structure is required.

### BRIEF SUMMARY OF THE INVENTION

An object of the present invention is to provide a liquid crystal display device that is capable of preventing inverse-transfer from a bend alignment to a splay alignment without degrading the luminance of a display panel.

According to the present invention, there is provided a liquid crystal display device comprising: a display panel including a pair of electrode substrates and a liquid crystal layer that is held between the pair of electrode substrates and contains a liquid crystal material whose molecules are transferred in advance from a splay alignment to a bend alignment for a display operation; and a control circuit that controls transmittance of the display panel by a liquid crystal driving voltage applied from the pair of electrode substrates to the liquid crystal layer in the display operation, wherein the display panel has a voltage-transmittance characteristic that a minimum value and maximum value of the transmittance are obtained in a state where the liquid crystal driving voltage exceeds a transfer threshold level at which an energy of the splay alignment is balanced with an energy of the bend alignment, and the control circuit is configured to vary the liquid crystal driving voltage in a range corresponding to the minimum and maximum values of transmittance.

In the liquid crystal display device, the transmittance of the display panel takes the minimum and maximum values in a state where the liquid crystal driving voltage exceeds the transfer threshold level. For this display panel, the control circuit is configured to vary the liquid crystal driving voltage in the range corresponding to the minimum and maximum values of transmittance. Accordingly, the inverse-transfer from the bend alignment to the splay alignment can be prevented without requiring conventional black insertion driving that degrades the luminance of the display panel. In addition, a complicated circuit configuration for black insertion driving is not necessary.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows the circuit configuration of a liquid crystal display device according to a first embodiment of the present invention;

FIG. 2 is a graph showing the liquid crystal driving voltage versus relative luminance (transmittance) characteristic of a liquid crystal display panel shown in FIG. 1;

FIG. 3 shows the polarities of line-reversal driving, which is applied to the liquid crystal display panel shown in FIG. 1;

FIG. 4 shows waveforms of a pixel voltage and a common voltage, which are applied to a pixel shown in FIG. 1;

FIG. 5 schematically shows the circuit configuration of a liquid crystal display device according to a second embodiment of the present invention;

FIG. 6 shows waveforms of a pixel voltage and a common voltage, which are applied to a pixel shown in FIG. 5;

FIG. 7 shows liquid crystal molecules that are transferred from a splay alignment to a bend alignment in order to perform a display operation; and

FIG. 8 is a graph showing energies of the splay alignment and bend alignment, relative to the liquid crystal driving voltage.

### DETAILED DESCRIPTION OF THE INVENTION

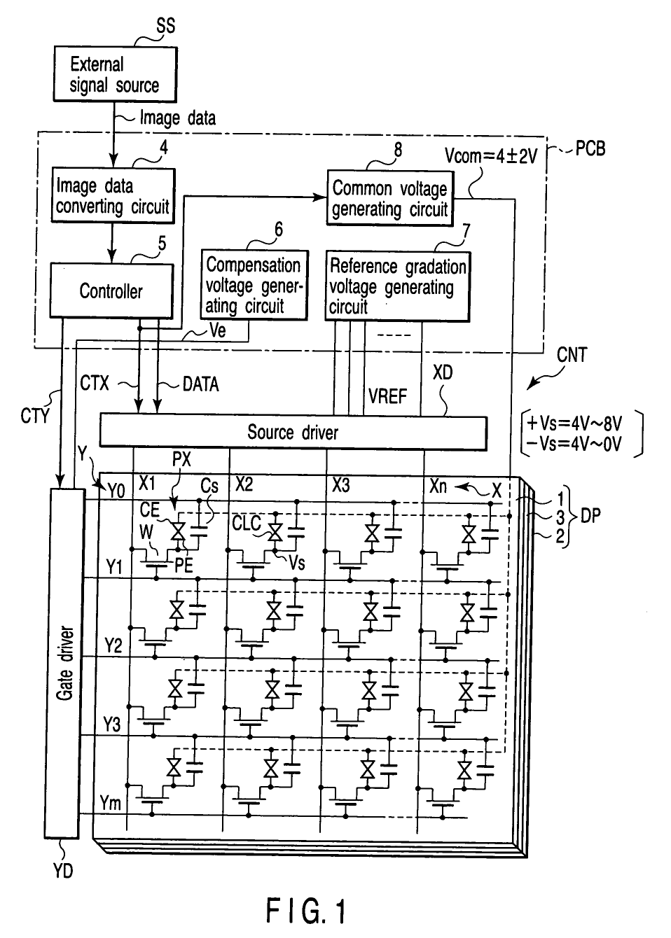

A liquid crystal display device according to a first embodiment of the present invention will now be described with reference to the accompanying drawings. FIG. 1 schematically shows the circuit configuration of the liquid crystal display device. The liquid crystal display device comprises a liquid crystal display panel DP and a display panel control circuit CNT. The liquid crystal display panel DP has a structure that a liquid crystal layer 3 is held between an array substrate 1 and a counter substrate 2, which are a pair of electrode substrates. The liquid crystal layer 3 contains a liquid crystal material whose molecules are transferred in advance from a splay alignment to a bend alignment for a display operation, such as a normally-white display operation, in an OCB mode. The display panel control circuit CNT controls the transmittance of the liquid crystal display panel DP by a liquid crystal driving voltage Vp that is applied to the liquid crystal layer 3 via the array substrate 1 and counter substrate 2. The transfer from the splay alignment to the bend alignment is attainable in a predetermined initializing process that is performed by the display panel control circuit CNT upon supply of power to apply a relatively strong electric field to the liquid crystal molecules. The liquid crystal display panel DP has a voltage-transmittance characteristic that a minimum value and maximum value of the transmittance are obtained in a state where the liquid crystal driving voltage Vp exceeds a transfer threshold level Vc at which an energy of the splay alignment is balanced with an energy of the bend alignment, and the display panel control circuit CNT is configured to vary the liquid crystal driving voltage in a range corresponding to the minimum and maximum values of the transmittance.

The array substrate 1 includes a plurality of pixel electrodes PE that are arrayed substantially in a matrix on a transparent insulating substrate of, e.g. glass; a plurality of gate lines Y (Y0 to Ym) that are arranged along the rows of pixel electrodes PE; a plurality of source lines X (X1 to Xn) that are arranged along the columns of pixel electrodes PE; and a plurality of pixel switching elements W that are disposed near intersections between the gate lines Y and source lines X, each pixel switching element W being rendered conductive between the associated source line X and associated pixel electrode PE when driven via the associated gate line Y. Each of the pixel switching elements W is composed of, e.g. a thin-film transistor. The thin-film transistor has a gate connected to the associated gate line Y, and a source-drain path connected between the associated source line X and pixel electrode PE.

The counter substrate 2 includes a color filter, which is disposed on a transparent insulating substrate of, e.g. glass, and a common electrode CE that is disposed on the color filter so as to be opposed to the pixel electrodes PE. The pixel electrode PE and the common electrode CE are each formed of a transparent electrode material such as ITO, and are coated with alignment layers that are subjected to rubbing treatment in directions parallel to each other. Each pair of the pixel electrode PE and the common electrode CE is associated with a pixel area of the liquid crystal layer 3 to form a pixel in which the alignment of liquid crystal molecules is controlled according to an electric field from the pixel electrode PE and common electrode CE.

Each of the liquid crystal pixels PX has a liquid crystal capacitance CLC between the associated pixel electrode PE and the common electrode CE, and is connected to one end of an associated one of storage capacitances Cs. Each storage capacitance Cs is formed by capacitive-coupling between the pixel electrode PE of one pixel PX and the gate line Y of a preceding stage, which controls the pixel switching element for another pixel PX neighboring the pixel PX on one side. The storage capacitance Cs is sufficiently greater than a parasitic capacitance of the pixel switching element W. FIG. 1 omits depiction of dummy pixels formed outside the matrix array of the pixels PX that serves as the display screen. The dummy pixels are wired like the pixels PX within the display screen, and are provided to set all the pixels PX within the display screen under the same conditions with respect to parasitic capacitance, etc. The gate line Y0 is a gate line for such dummy pixels.

The display panel control circuit CNT includes a gate driver YD that sequentially drives the gate lines Y0 to Ym so as to turn on the switching elements W on a row-by-row basis; a source driver XD that outputs pixel voltages Vs to the source lines X1 to Xn in a period the switching elements W on each row are driven via the associated gate line Y; an image data converting circuit 4 that converts a resolution, a gradation, etc. of image data comprising a plurality of pixel data for the pixels PX that are input from an external signal source SS in every 1-frame period (vertical scanning period); and a controller 5 that controls the operation timings, etc. of the gate driver YD and source driver XD to perform a display for the image data obtained as a conversion result from the image data converting circuit 4. The pixel voltage Vs is a voltage that is applied to the pixel electrode PE with respect to a common voltage Vcom of the common electrode CE. The polarity of the pixel voltage Vs is reversed, relative to the common voltage Vcom, so as to perform, e.g. frame-reversal driving and line-reversal driving.

The gate driver YD and source driver XD are, for instance, integrated circuit (IC) chips that are mounted on a flexible wiring sheet, which is disposed along outer edges of the array substrate 1. On the other hand, the image data converting circuit 4 and controller 5 are disposed on an external printed circuit board PCB. The controller circuit 5 generates a control signal CTY for sequentially driving the gate lines Y, as mentioned above, and a control signal CTX that assigns pixel data DATA, that are serially output in units of pixels PX for one row as a conversion result from the image data converting circuit 4, to the source lines X, and designates the output polarity. The control signal CTY is supplied from the controller 5 to the gate driver YD. The control signal CTX is supplied from the controller 5 to the source driver XD, together with the pixel data DATA that are obtained as a conversion result from the image data converting circuit 4.

The display panel control circuit CNT further includes a compensation voltage generating circuit 6, a reference gradation voltage generating circuit 7, and a common voltage generating circuit 8. The compensation voltage generating circuit 6 generates a compensation voltage Ve that is applied, when switching elements W on one row are rendered non-conductive, via the gate driver YD to a preceding-stage gate line Y, which neighbors, on one side, a gate line Y connected to these switching elements W, and that compensates a variation in the pixel voltages Vs, which occur in the pixels PX on the associated row due to parasitic capacitances of these switching elements W. The reference gradation voltage generating circuit 7 generates a predetermined number of reference gradation voltages VREF that are used in order to convert the image data DATA to the pixel voltage Vs. The common voltage generating circuit 8 generates a common voltage Vcom, the level of which is shifted in every 1 horizontal scanning period (1H). In this embodiment, the common voltage generating circuit 8 refers to the output polarity, which is designated by the control signal CTX from the controller 5, and alternately sets the common voltage Vcom at Vcomc+2V and at Vcomc−2V, relative to a center level Vcomc (=4V).

Under the control of the control signal CTY, the gate driver YD sequentially selects the gate lines Y1 to Ym in every 1-frame period, and supplies to the selected gate line Y an ON-voltage for turning on the pixel switching elements W on each row for only one horizontal scanning period. The image data converting circuit 4 outputs pixel data DATA for one row of pixels PX as a conversion result in every 1 horizontal scanning period. The source driver XD converts the pixel data DATA to pixel voltages Vs with reference to the predetermined number of reference gradation voltages VREF supplied from the reference gradation voltage generating circuit 7, and outputs the pixel voltages Vs to the source lines X1 to Xn in parallel.

Assume now that the gate driver YD drives the gate line Y1, for instance, by an ON-voltage, and turns on all pixel switching elements W that are connected to the gate line Y1. In this case, the pixel voltages Vs on the source lines X1 to Xn are applied via the pixel switching elements W to the associated pixel electrodes PE and to terminals at one end of the associated storage capacitances Cs. In addition, the gate driver YD outputs the compensation voltage Ve from the compensation voltage generating circuit 6 to the preceding-stage gate line Y0 that neighbors the gate line Y1. Immediately after turning on all pixel switching elements W, which are connected to the gate line Y1, for only one horizontal scan period, the gate driver YD outputs to the gate line Y1 an OFF-voltage that turns off the pixel switching elements W. When the pixel switching elements W are turned off, the compensation voltage Ve reduces the amount of charge that is to be extracted from the pixel electrodes PE due to the parasitic capacitances of the pixel switching elements W, thereby substantially canceling a variation in pixel voltage Vs, that is, a field-through voltage ΔVp.

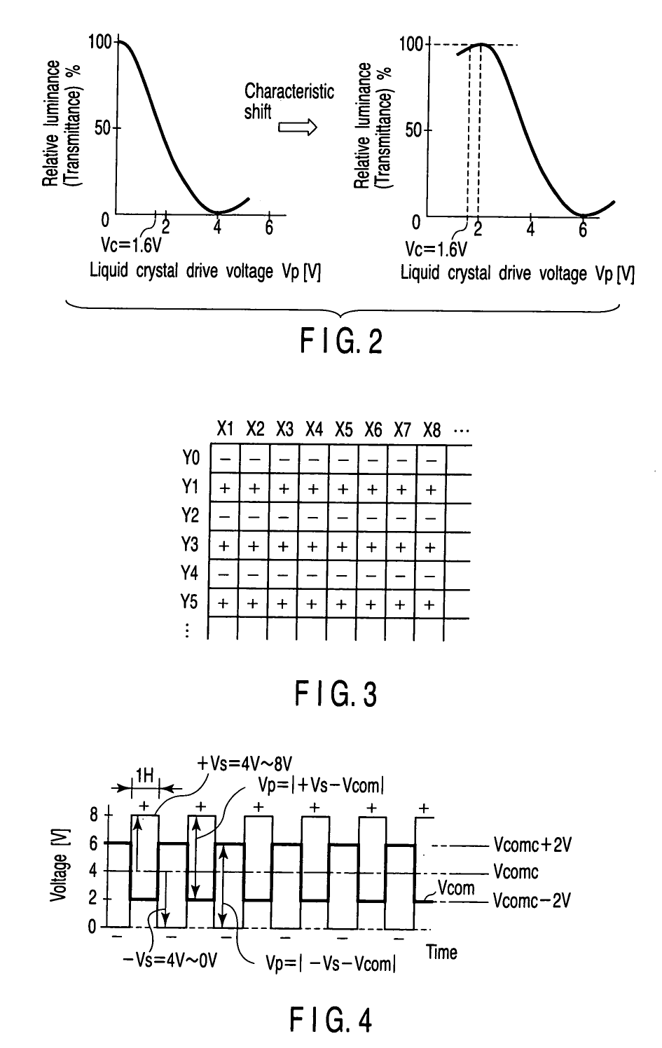

FIG. 2 is a graph showing the liquid crystal driving voltage versus relative luminance (transmittance) characteristic, which is shifted in the liquid crystal display panel DP shown in FIG. 1. In FIG. 2, a characteristic graph on the left part shows the liquid crystal driving voltage versus relative luminance (transmittance) characteristic in a typical liquid crystal display panel. In this case, the transfer threshold level Vc (=1.6V), at which the energy of splay alignment is balanced with the energy of bend alignment, is present in a range of 0V to 4V of the liquid crystal driving voltage Vp, which corresponds to the minimum value (=0%) and maximum value (=100%) of the transmittance. In order to prevent inverse-transfer from the bend alignment to splay alignment, it is a possible method to vary the liquid crystal driving voltage Vp in a range between 1.6V and 4V. In this method, however, the transmittance at a time of maximum gradation is limited to less than 100% according to the characteristic curve, and the dynamic range decreases. By contrast, in the liquid crystal display panel DP shown in FIG. 1, a retardation value Δnd of the liquid crystal layer 3 is made greater than a typical one, and the liquid crystal driving voltage versus relative luminance (transmittance) characteristic is shifted, as shown in a characteristic graph in the right part of FIG. 2. Specifically, the thickness of the liquid crystal layer 3 is set at 4 μm or more, and the refractive index anisotropy Δn of the liquid crystal is set at 0.165 or more. In this case, the transfer threshold level Vc (=1.6V) is present as a voltage level below a range of 2V to 6V of the liquid crystal driving voltage Vp, which corresponds to the minimum value (=0%) and maximum value (=100%) of the transmittance. Thus, when the liquid crystal driving voltage Vp is varied in the range of 2V to 6V, the relationship, Vc (=1.6V) <Vp (=2V to 6V), is established. Therefore, the liquid crystal molecules are always maintained in the bend alignment, and the transmittance at the time of maximum gradation can be set at 100% in accordance with the characteristic curve.

As is shown in FIG. 3, the polarity of the pixel voltage Vs is reversed, relative to the common voltage Vcom, on a row-by-row basis. If a positive pixel voltage is represented by +Vs and a negative pixel voltage is represented by −Vs, +Vs=4V to 8V, and −Vs=4V to 0V. The common voltage Vcom is set at Vcom±2V in order to set the lower limit of the liquid crystal driving voltage Vp at 2V, at which the transmittance of 100% can be obtained without unnecessarily increasing the amplitude of the pixel voltage Vs. If the pixel voltage Vs and common voltage Vcom synchronously vary in every 1 horizontal scanning period (1H), as shown in FIG. 4, the liquid crystal driving voltage Vp becomes Vp=|+Vs−Vcom| or Vp=|−Vs−Vcom|, and falls in the range of 2V to 6V in either pixel voltage polarity.

Specifically, the display panel control circuit CNT performs the operation of applying the pixel voltages Vs, which have an amplitude corresponding to the minimum value and maximum value of the transmittance, to the pixel electrodes PE from the source driver XD via the switching elements W, applying the common voltage Vcom, which corresponds to the transfer threshold level Vc, to the common electrode CE from the common voltage generating circuit 8, and setting the pixel voltages Vs and common voltage Vcom so as to cyclically reverse the polarity of the liquid crystal driving voltage Vp.

In the liquid crystal display device of this embodiment, the transmittance of the display panel DP takes the minimum and maximum values in a state where the liquid crystal driving voltage Vp exceeds the transfer threshold level Vc. For this display panel DP, the display panel control circuit CNT is configured to vary the liquid crystal driving voltage Vp in the range corresponding to the minimum and maximum values of transmittance. Accordingly, the inverse-transfer from the bend alignment to the splay alignment can be prevented without requiring conventional black insertion driving that degrades the luminance of the display panel DP. In addition, a complicated circuit configuration for black insertion driving is not necessary.

Next, a liquid crystal display device according to a second embodiment of the invention will be described.

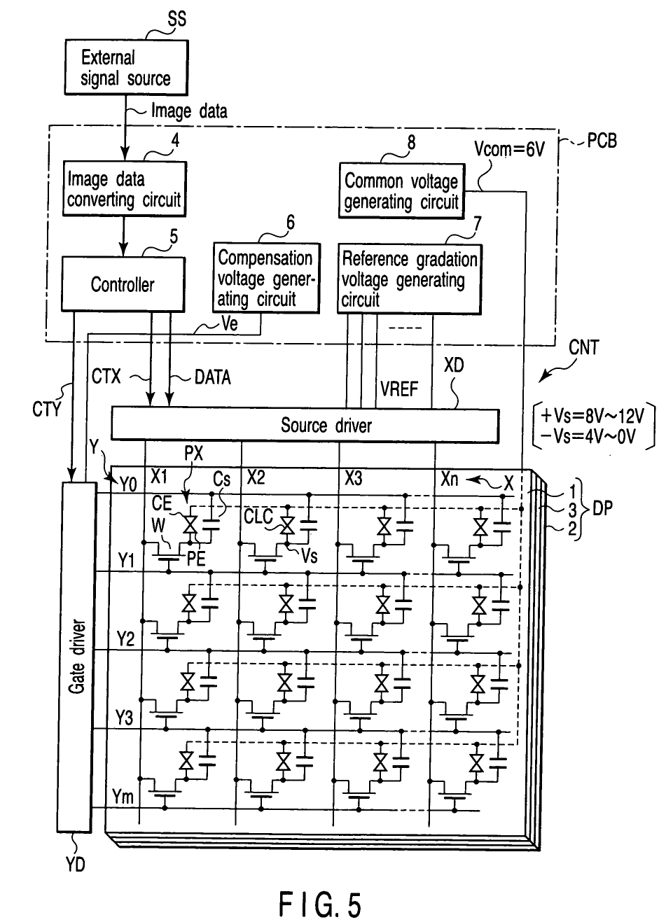

FIG. 5 schematically shows the circuit configuration of the liquid crystal display device. The second embodiment differs from the above-described first embodiment in that the common voltage Vcom is fixed to obtain the liquid crystal driving voltage Vp having a range of 2V to 6V in the crystal display panel DP having the liquid crystal driving voltage versus relative luminance (transmittance) characteristic as shown in the right part of FIG. 2. In FIG. 5, the parts common to those in the first embodiment are denoted by the same reference symbols, and a detailed description thereof is simplified or omitted.

In the liquid crystal display panel DP shown in FIG. 5, the thickness of the liquid crystal layer 3 is also set at 4 μm or more, and the refractive index anisotropy Δn of the liquid crystal is set at 0.165 or more. The common voltage generating circuit 8 generates a common voltage Vcom, which is fixed at 6V, regardless of the control signal CTX that is output from the controller 5. Instead, the amplitude of the pixel voltage Vs, which is generated from the source driver XD, is altered. Specifically, the positive pixel voltage is altered to +Vs=8V to 12V, and the negative pixel voltage is altered to −Vs=4V to 0V.

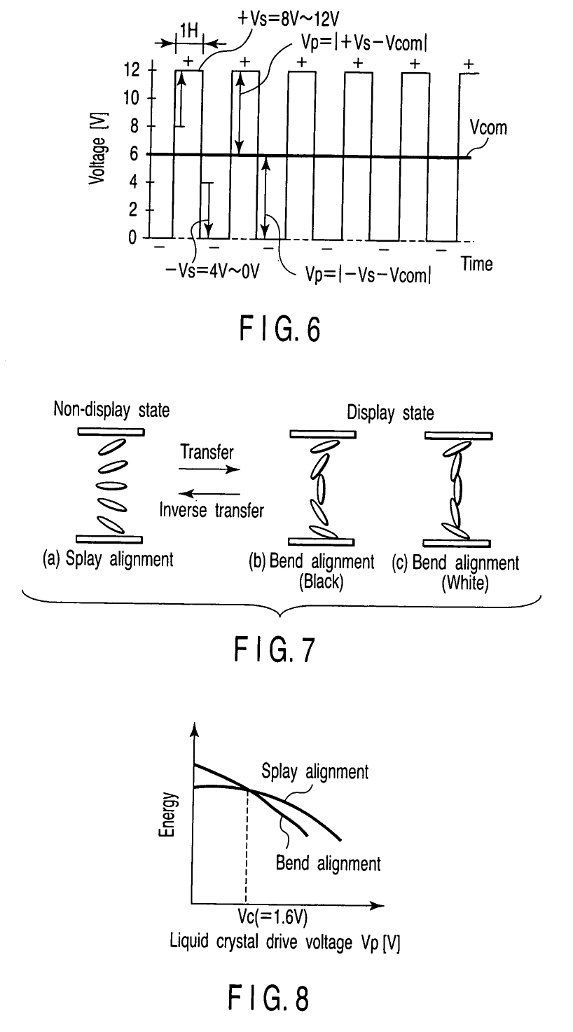

If the pixel voltage Vs varies in every 1 horizontal scanning period (1H), as shown in FIG. 6, the liquid crystal driving voltage Vp becomes Vp=|+Vs−Vcom| or Vp=|−Vs−Vcom|, and falls in the range of 2V to 6V in either pixel voltage polarity.

Specifically, the display panel control circuit CNT performs the operation of applying the pixel voltage Vs, which is obtained by adding the amplitude corresponding to the minimum value and maximum value of the transmittance to the amplitude corresponding to the transfer threshold level Vc, to each of the pixel electrodes PE from the source driver XD via the switching element W, applying the fixed common voltage Vcom to the common electrode CE from the common voltage generating circuit 8, and setting the pixel voltage Vs so as to cyclically reverse the polarity of the liquid crystal driving voltage Vp.

In the liquid crystal display device according to this embodiment, it is necessary to raise the withstand voltage of the source driver XD so as to match with the output amplitude that becomes greater than in the first embodiment. However, the same advantageous effect as in the first embodiment can be obtained. Specifically, the transmittance of the display panel DP takes the minimum and maximum values in a state where the liquid crystal driving voltage Vp exceeds the transfer threshold level Vc. For this display panel DP, the display panel control circuit CNT is configured to vary the liquid crystal driving voltage Vp in the range corresponding to the minimum and maximum values of transmittance. Accordingly, the inverse-transfer from the bend alignment to the splay alignment can be prevented without requiring conventional black insertion driving that degrades the luminance of the display panel DP. In addition, a complicated circuit configuration for black insertion driving is not necessary.

The present invention is not limited to the above-described embodiments, and various modifications can be made without departing from the spirit of the invention.

For example, the liquid crystal display panel DP shown in FIG. 1 may include a plurality of storage capacitance lines which are provided in parallel to the source liens X and each of which is capacitively coupled to the pixel electrodes PE of an associated column in order to bias the pixel voltage Vs by a bias voltage which corresponds to the pixel voltage polarity and is applied from the display panel control circuit CNT to the pixel electrode PE via a selected one of the storage capacitance lines, thereby setting the liquid crystal driving voltage Vp in the range of 2V to 6V. In the case where the common voltage generating circuit 8 is configured to generate a common voltage Vcom fixed at 4V, it is not necessary to alter the amplitude of the pixel voltage Vs output from the source driver XD.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A liquid crystal display device comprising:
a display panel including a pair of electrode substrates and a liquid crystal layer that is held between the pair of electrode substrates and contains a liquid crystal material whose molecules are transferred in advance from a splay alignment to a bend alignment for a display operation; and
a control circuit that controls transmittance of the display panel by a liquid crystal driving voltage applied from the pair of electrode substrates to the liquid crystal layer in the display operation;
wherein the display panel has a voltage-transmittance characteristic that a minimum value and maximum value of the transmittance are obtained in a state where the liquid crystal driving voltage exceeds a transfer threshold level at which an energy of the splay alignment is balanced with an energy of the bend alignment, and the control circuit is configured to vary the liquid crystal driving voltage in a range corresponding to the minimum and maximum values of transmittance.

2. The liquid crystal display device according to claim 1, wherein one of the pair of electrode substrates includes a plurality of pixel electrodes, the other of the pair of electrode substrates includes a common electrode that is opposed to the pixel electrodes, the display panel control circuit includes a driver circuit that applies a pixel voltage of an amplitude corresponding to the minimum value and maximum value of the transmittance to each of the pixel electrodes via a switching element, and a common voltage generating circuit that applies a common voltage corresponding to the transfer threshold level to the common electrode, and the pixel voltage and the common voltage are set to cyclically reverse a polarity of the liquid crystal driving voltage.

3. The liquid crystal display device according to claim 1, wherein one of the pair of electrode substrates includes a plurality of pixel electrodes, the other of the pair of electrode substrates includes a common electrode that is opposed to the plurality of pixel electrodes, the display panel control circuit includes a driver circuit that applies pixel voltages, which are obtained by adding an amplitude corresponding to the transfer threshold level to an amplitude corresponding to the minimum value and maximum value of the transmittance, to the plurality of pixel electrodes via switching elements, and a common voltage generating circuit that applies a fixed common voltage to the common electrode, and the pixel voltages are set to cyclically reverse a polarity of the liquid crystal driving voltage.

4. The liquid crystal display device according to claim 1, wherein the liquid crystal material is material for an OCB mode.

5. A liquid crystal display device comprising:
a display panel including a pair of electrode substrates and a liquid crystal layer that is held between the pair of electrode substrates and contains a liquid crystal material set in a bend alignment for a display operation; and
a control circuit that drives the pair of electrode substrates to apply a liquid crystal driving voltage to the liquid crystal layer in the display operation;
wherein retardation of the liquid crystal layer is such that the display panel have a voltage-transmittance characteristic that a minimum value and maximum value of transmittance are obtained in a state where the liquid crystal driving voltage exceeds a transfer threshold level at which an energy of a splay alignment is balanced with an energy of the bend alignment.
